(19) United States
(12) Patent Application Publication
(10) Pub. No.: US 2003/0104863 A1
(43) Pub. Date: Jun. 5, 2003

(54) Savings system using online game and storage medium therefor

(76) Inventor: Seokyu Park, Seoul (KR)

Correspondence Address: Thomas R Fitzgerald, Suite 210, 16 E Main Street, Rochester, NY, 14614-1803, US

(21) Appl. No.: 10/258,292

(22) PCT Filed: Mar. 14, 2001
(86) PCT No.: PCT/KR01/00400

(30) Foreign Application Priority Data
Nov. 13, 2000 (KR) 2000/67246

(51) Int. Cl. G06F 17/00

(52) U.S. Cl. 463/25

(57) ABSTRACT

A savings system using an online game and a storage medium therefor, wherein a member plays the game for money on the Internet; if the member wins the game, he obtains a profit whereas if the member loses the game, he is compelled to deposit a lost amount of money in a bank; and as a consequence, the member is guaranteed the principal at least.

### BACKGROUND OF THE INVENTION

1. Field of the Invention

The present invention relates in general to a savings system using an online game and a storage medium therefor, and more particularly to a savings system using an online game and a storage medium therefor, wherein a member plays the game for money on the Internet; if the member wins the game, he obtains a profit whereas if the member loses the game, he is compelled to deposit a lost amount of money in a bank; and as a consequence, the member is guaranteed the principal at least.

2. Description of the Prior Art

Currently, arcade games and role-playing games are prevailing online games over the Internet. Of the online games, there are speculative games such as poker, go-stop (Japanese playing card game) which invite a user to play games, betting points and cyber money. Recently, there has been developed a method of enabling a user to insert his credit card number in order to play a game, and thereafter, a certain amount of money is withdrawn directly from his bank account or is deposited into his account.

However, those card games or casino games foster a speculative spirit of the user. Further, these games make the user addicted thereto, thereby causing a social problem. To solve such problem, some countries prohibit the game itself by law. However, considering that there are no physical boundaries between countries over the Internet, it is doubtful whether such prohibition will be able to obtain the desired effect. Further, in order to avoid such a lawful ban, modified games are unlawfully operated.

### SUMMARY OF THE INVENTION

Accordingly, the present invention has been made keeping in mind the above-described problems, and it is an object of the present invention to provide a savings system using an online game and a storage medium therefor, wherein a member can obtain a profit if he wins the game and further he can retain the principal at least even if he loses the game.

Another object of the present invention is to provide a savings system using an online game and a storage medium therefor, increasing the savings deposited in a bank, through the game.

Still another object of the present invention is to provide a savings system using an online game and a storage medium therefor, allowing a member to make a profit through the interest from a fixed deposit.

In accordance with one aspect of the present invention, the above and other objects can be accomplished by the provision of a savings device using an online game, comprising electronic game means operated by commands internally decided and data input and output through the Internet, through which a member wagers a given amount of money on the game, and makes a profit or loses a certain amount of money according to a result of the game; transfer means for opening an account for a bound deposit in a specific bank in an operator's name and transferring money of the amount lost by the member to the bound deposit account; communicator means for communicating a number of the bound deposit account, a depositor's name and an expiration date to the operator and member, and returning means for awarding prize money to the member if he wins the game and returning to the member the principal when the term of the deposit expires.

Preferably, the bound deposit account may be opened when an accumulated amount of money lost by the member exceeds a predetermined amount of money.

The online game may preferably be an electronic card game, electronic casino game or electronic horse race game.

The bound deposit may preferably be a fixed deposit.

In accordance with another aspect of the present invention, there is provided a savings method using an online game, comprising the steps of allowing a member to participate in the online game by wagering a given amount of money on it; playing the game; determining whether the member loses a certain amount of money as a result of the game; accumulating the certain amount of money if the member loses it and transferring the accumulated amount of money to an account for a bound deposit of a specific bank; returning to the member the principal of the deposit when the expiry term of the deposit approaches; delivering interest receipts of the deposit to an operator; and awarding prize money if the member wins the game.

Preferably, the above transfer step may include the steps of accumulating the certain amount of money lost by the member in the game; determining whether the accumulated amount of money exceeds a predetermined amount of money; delivering information regarding the predetermined amount of money and the term of the deposit to the specific bank if the accumulated amount of money exceeds the predetermined amount of money; opening the bound deposit account to the operator's name in the specific bank and transferring the predetermined amount of money to the bound deposit account; and delivering information regarding a number of the bound deposit account, an expiration date and a returning method to the operator and member.

The bound deposit may preferably be a fixed deposit.

In accordance with yet another aspect of the present invention, there is provided a storage medium for a savings system using an online game, comprising a program code for operating the online game based on a given amount of money bet by a member; a program code for determining whether the member loses a certain amount of money as a result of the game; a program code for accumulating the certain amount of money lost by the member in the game if the member loses it, determining whether the accumulated amount of money exceeds a predetermined amount of money and delivering information regarding the predetermined amount of money and the term of a deposit to a specific bank if the accumulated amount of money exceeds the predetermined amount of money; a program code for opening an account for a bound deposit to an operator's name in the specific bank and transferring the predetermined amount of money to the bound deposit account; a program code for delivering information regarding a number of the bound deposit account, an expiration date and a returning method to the operator and member; a program code for returning to the member the principal of the deposit and delivering interest receipts of the deposit to the operator when the expiry term of the deposit approaches; and a program code for awarding prize money if the member wins the game.

The storage medium may preferably be a floppy disk, compact disk read only memory, compact disk hard disk, read only memory chip or digital video disk.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a view schematically showing the construction of a savings system using an online game according to a preferred embodiment of the present invention;

FIG. 2 is a block diagram schematically illustrating a data flow of a game machine in FIG. 1;

FIG. 3 is a schematic diagram of a window displayed on a monitor when the online game is played according to this invention;

FIG. 4 is a schematic diagram of a window for transferring information regarding an account for a fixed deposit, which is opened based on a certain amount of money lost by a member, to an operator and the member,

FIG. 5 is a flowchart illustrating a savings method using an online game according to the preferred embodiment of the present invention; and

FIG. 6 is a flowchart illustrating a transfer step in FIG. 5 in detail.

### DETAILED DESCRIPTION OF THE PREFERRED EMBODIMENTS

Hereinbelow, the present invention will be described in detail with reference to the accompanying drawings.

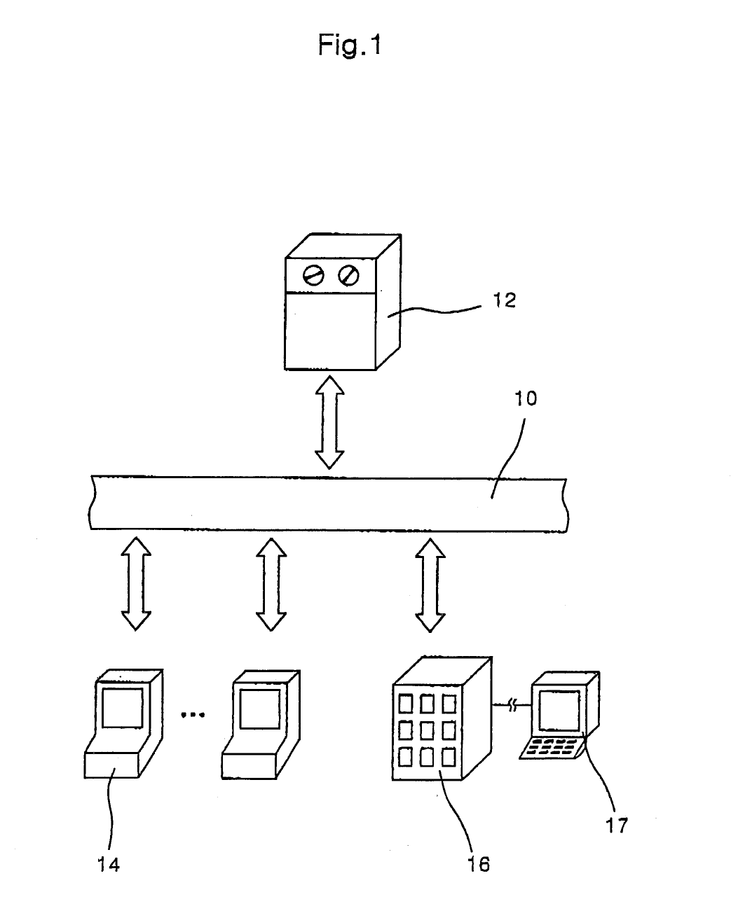

Referring to FIG. 1 which is a schematic diagram of a savings system using an online game according to a preferred embodiment of the present invention, an operator server 12, a plurality of game machines 12, a bank 16 and a server 17 of the bank 16 are interconnected through the Internet 10.

The operator server 12 is operated by a Windows NT or UNIX system and configured to exchange data in a TCP/IP manner over the Internet 10. If necessary, the operator server 12 can transmit game programs to the game machines 14.

The game machines 14 may be special game machines in game stores capable of Internet communication, play stations and Sega, and casino game machines connected by a modem or a LAN, etc. With PDAs, cellular phones, pagers, notebook computers, etc. capable of wireless Internet communications, Internet games may be played. The games can be played simultaneously between a plurality of the game machines 14 networked through the Internet 10.

The bank 16 is a banking institution handling a bound deposit such as a fixed deposit, etc., typically including commercial banks, insurance companies and trust companies, etc. The bank 16 manages computerized data about customers and banking transactions and stores them in the bank server 17.

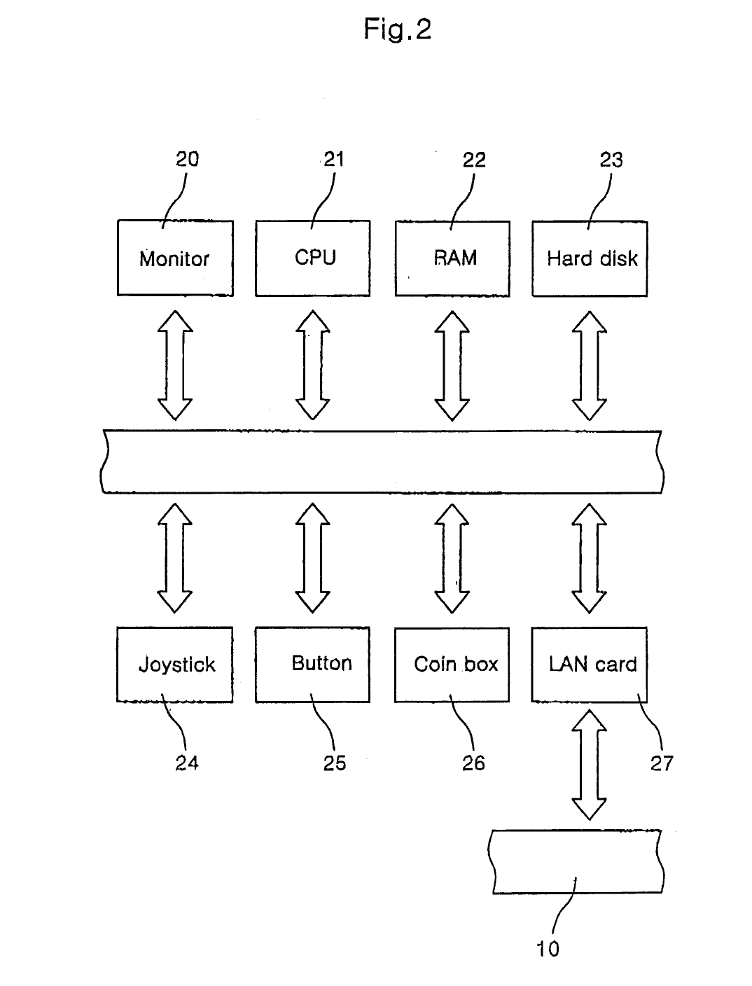

As shown in FIG. 2 which is a schematic block diagram illustrating a data flow of each game machine 14 in FIG. 1, the game machine 14 is comprised of a monitor 20 for displaying a state of a game being played thereon, a central processing unit (CPU) 21 for performing control and operational tasks, a main memory 22 such as a random access memory (RAM), a hard disk 23 for storing data of the game program therein and reading out the game program data therefrom, a joystick 24 for moving an icon to a position directed by a member, a button 25 for inputting a variety of details, a coin box 26 for inserting a coin or paper money, and a LAN card allowing a communication with the Internet 10.

In order to play a game, the member pays a certain amount of money to be bet by entering a number of his credit card by the joystick 24 and the button 25, by utilizing electronic money such as Mondex, or by directly entering cash into the coin box 26. Game data and information about the member can be transmitted to the outside through the LAN card 27 and any necessary information may be entered from the operator server 12.

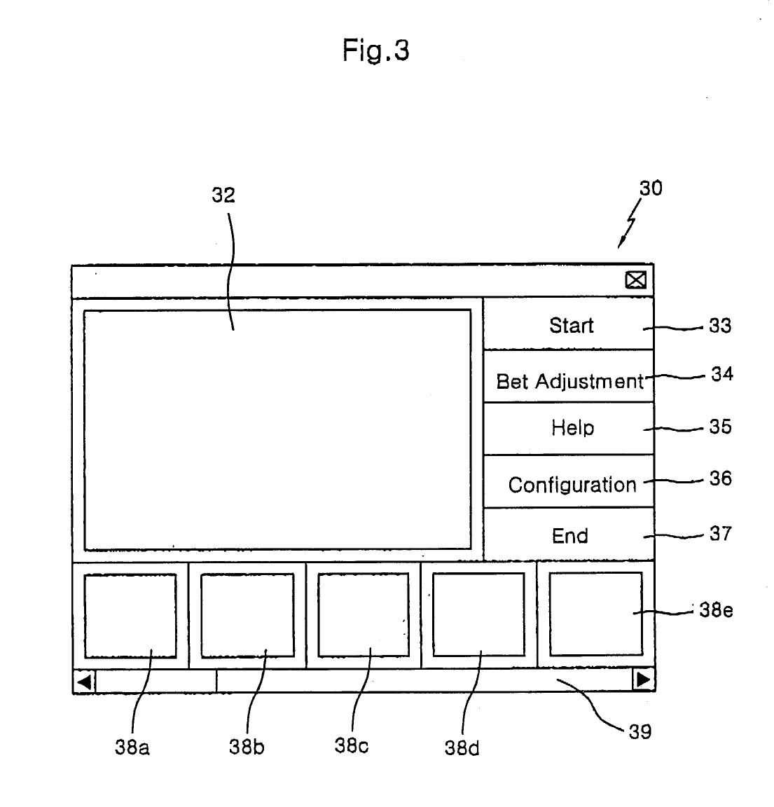

FIG. 3 is a schematic diagram of a window 30 displayed on the monitor 20 when the online game is played according to the present invention. The online game, which may be a card game, casino game or go-stop game, is played on a main screen 32, and therefore, the member can play the game while viewing the main screen 32. A plurality of buttons 33, 34, 35, 36 and 37 are disposed in the right of the window screen 30. For example, the buttons may be respectively for Game Start 33, Bet Adjustment 34, Help 35, Configuration 36 for arranging options such as sound, color, etc., and End 37 for terminating the game.

In the lower portion of the main screen 32 are disposed a plurality of auxiliary screens 38 for displaying states of the game being played by the members in access to the operator server 12 by employing a mechanism of thumb nails. For example, if a member is currently playing a game together with the other five members, his game state is displayed in the main screen 32 and the other five members' game states are displayed in the auxiliary screens 38a, 38b, 38c, 38d and 38e.

The five auxiliary screens 38a, 38b, 38c, 38d and 38e may be configured to be updated and then displayed sequentially, e.g., with an interval of ⅕ seconds. Thus, the member can easily and readily learn the states of his and the others' games. The number of auxiliary screens 38 can be increased or decreased appropriately according to the number of members currently connected; if necessary, they can be moved horizontally by a scroll bar 39.

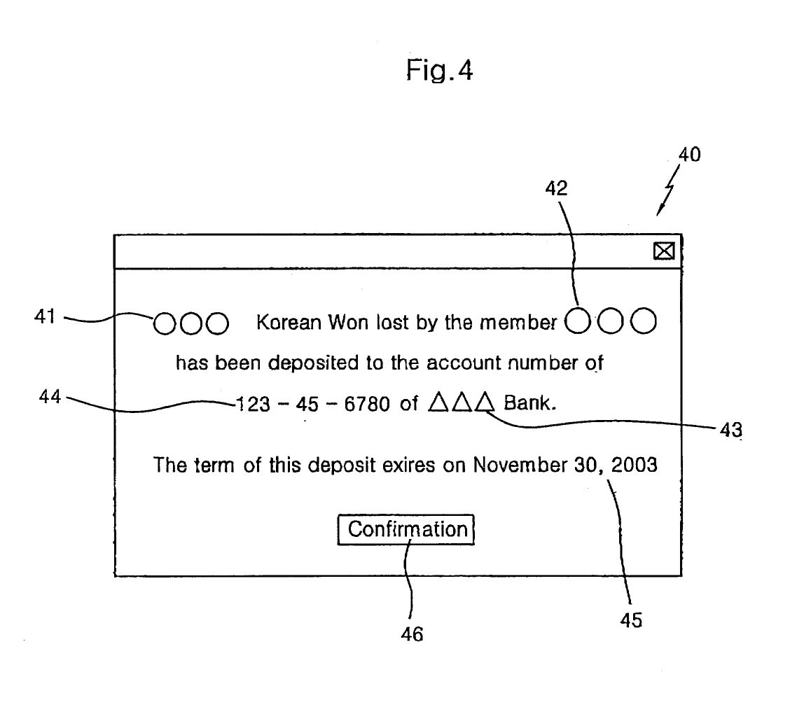

Referring to FIG. 4 which is a schematic diagram of a window 40 for transferring information regarding an account for a fixed deposit, which is opened based on a certain amount of money lost by a member, to the operator and member, an ID 41 of the member, money amount 42, bank's name 43, bank account number 44, expiration date 45 and confirmation button 46 are displayed in the window screen 40.

Where a fixed deposit account is opened, the operator server 12 generates the window 40 as illustrated in FIG. 4, based on data transferred from the bank, so as to inform the member of such a situation. For example, messages such as “300,000 Korean Won lost by the member ‘abcd’ has been deposited to the account number of 12345-6780 of Kookmin Bank. The deposit will expire on Nov. 30, 2003 ” appear in the window 40. The member can understand through the window screen 40 when he can withdraw the lost amount of money from the bank.

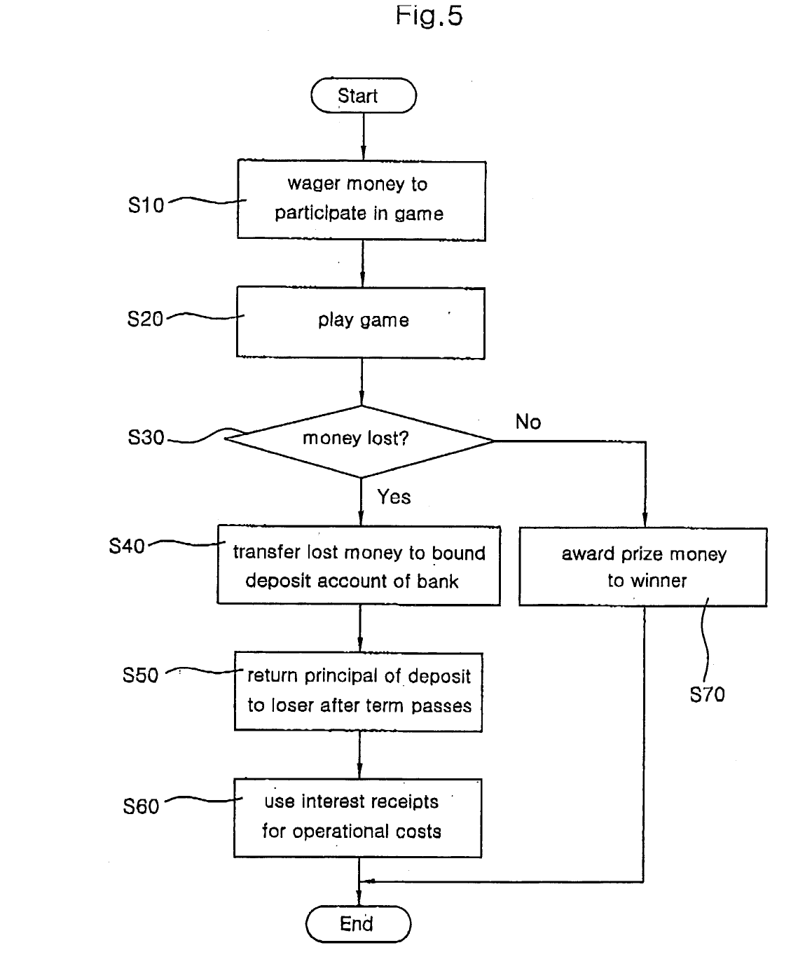

As shown in FIG. 5 which is a flowchart illustrating a savings method using an online game according to the preferred embodiment of the present invention, a member participates in the online electronic game by wagering a certain amount of money on it (S10). The member learns whether he loses the money or how much he makes a profit while the game is played (S20).

The operator server 12 determines whether the member lost the money as a result of the game (S30). Where the member lost the money, the accumulated amount of the lost money is transferred so as to be deposited into an account for a bound deposit (for example, a fixed deposit) opened in the bank 16 (S40). The principal is returned to the member when the deposit expires (S50). The interest receipts of the deposit are delivered to the operator (S60). The operator utilizes the interest receipts partially as prize money for other members and partially as capital for an operational cost as needed by the operator.

Where the accumulated amount of money lost by a plurality of members named A, B, . . . , through the game exceeds a predetermined amount of money, a fixed deposit account is opened in the operator's name. The operator manages data about a money amount allotted to each member from the deposited amount and stores them in the operator's server.

If the member wins the game, the operator awards the prize money to him (S70).

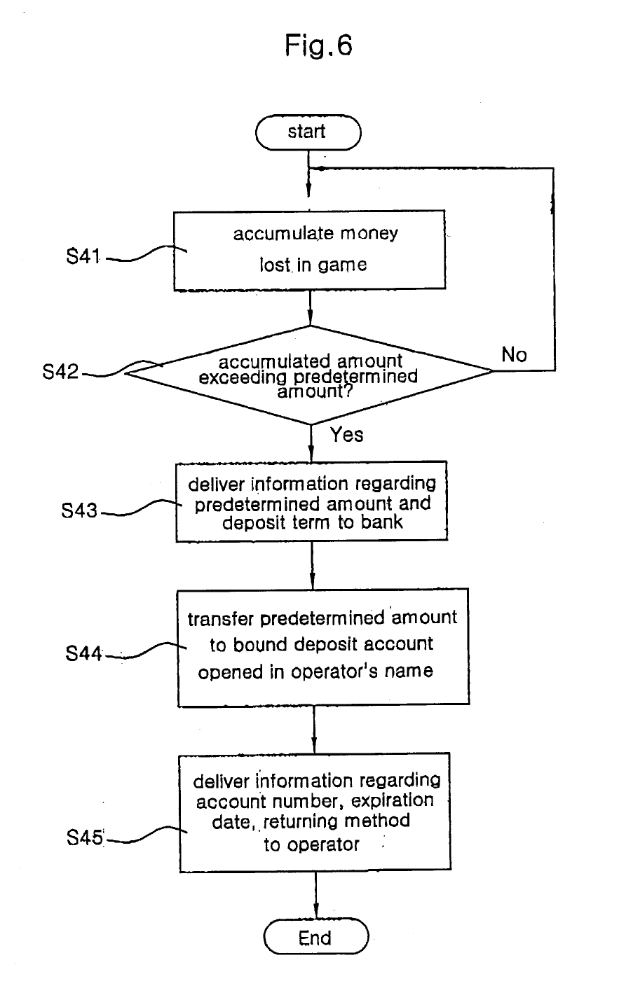

Referring to FIG. 6 which is a flowchart illustrating the transfer step S40 in FIG. 5 in detail, the operator server 12 accumulates the money lost by each member in the game (S41). Whether the accumulated amount is over a predetermined amount (for example, 300,000 Korean Won) is determined (S42). If the accumulated money is determined to be over KRW300,000, this amount is transferred to an associated bank 16, indicating the term of deposit, e.g., among six months, one year, one and a half years, two years, two and a half years and three years) (S43).

The bank receiving the money opens an account for a bound deposit (for example, a fixed deposit) in the operator's name and transfers it to the opened deposit account (S44), and transmits information regarding the account number, expiration date, and method of returning the money to the operator and the relevant member (S45).

Each member designates a deposit term among the term of six months, one year, one and a half years, two years, two and a half years or three years, simultaneously with wagering the money on it, before initiating a game. The lost money is accumulated according to the deposit term. If the accumulated amount of the lost money is in excess of a predetermined amount (e.g., 5,000,000 Korean Won), a fixed deposit account is opened in the operator's name according to the respective deposit term.

As described above, according to a savings system using an online game and a storage medium therefor of the present invention, a member can make a profit when he wins the game, and he can collect the principal at least even if he loses the game.

Advantageously, banks can increase the bank savings and encourage savings through games. In addition, the operator can make a profit based on the interest receipts received from the fixed bank.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A savings device using an online game, comprising:
electronic game means operated by commands internally decided and data input and output through the Internet, through which a member wagers a given amount of money on the game, and makes a profit or loses a certain amount of money according to a result of said game;
transfer means for opening an account for a bound deposit in a specific bank in an operator's name and transferring money of the amount lost by said member to said bound deposit account;
communicator means for communicating a number of said bound deposit account, a depositor's name and an expiration date to said operator and member; and
returning means for awarding prize money to said member if he wins said game and returning to said member the principal when the term of said deposit expires.

2. The savings device using an online game, as set forth in claim 1, wherein said bound deposit account is opened when an accumulated amount of money lost by said member exceeds a predetermined amount of money.

3. The savings device using an online game, as set forth in claim 1 or claim 2, wherein said online game includes an electronic card game.

4. The savings device using an online game, as set forth in claim 1 or claim 2, wherein said bound deposit includes a fixed deposit.

5. A savings method using an online game, comprising the steps of:
a) allowing a member to participate in the online game by wagering a given amount of money on it;
b) playing said game;
c) determining whether said member loses a certain amount of money as a result of said game;
d) accumulating the certain amount of money if said member loses it and transferring the accumulated amount of money to an account for a bound deposit of a specific bank;
e) returning to said member the principal of said deposit when the expiry term of said deposit approaches;
f) delivering interest receipts of said deposit to an operator, and
g) awarding prize money if said member wins said game.

6. The savings method using an online game, as set forth in claim 5, wherein said transfer step d) includes the steps of:
d-1) accumulating said certain amount of money lost by said member in said game;
d-2) determining whether the accumulated amount of money exceeds a predetermined amount of money;
d-3) delivering information regarding said predetermined amount of money and the term of said deposit to said specific bank if said accumulated amount of money exceeds said predetermined amount of money;
d-4) opening said bound deposit account to the operator's name in said specific bank and transferring said predetermined amount of money to said bound deposit account; and
d-5) delivering information regarding a number of said bound deposit account, an expiration date and a returning method to said operator and member.

7. The savings method using an online game, as set forth in claim 5 or claim 6, wherein said bound deposit includes a fixed deposit.

8. A storage medium for a savings system using an online game, comprising:
a program code for operating the online game based on a given amount of money bet by a member;
a program code for determining whether said member loses a certain amount of money as a result of said game;
a program code for accumulating the certain amount of money lost by said member in said game if said member loses it, determining whether the accumulated amount of money exceeds a predetermined amount of money and delivering information regarding said predetermined amount of money and the term of a deposit to a specific bank if said accumulated amount of money exceeds said predetermined amount of money;
a program code for opening an account for a bound deposit to an operator's name in said specific bank and transferring said predetermined amount of money to said bound deposit account;
a program code for delivering information regarding a number of said bound deposit account, an expiration date and a returning method to said operator and member;
a program code for returning to said member the principal of said deposit and delivering interest receipts of said deposit to said operator when the expiry term of said deposit approaches; and
a program code for awarding prize money if said member wins said game.
